(19) United States
(12) Patent Application Publication
(10) Pub. No.: US 2005/0146637 A1
(43) Pub. Date: Jul. 7, 2005

(54) Imaging apparatus

(75) Inventor: Takahiro Kawauchi, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/020,440

(22) Filed: Dec. 21, 2004

(30) Foreign Application Priority Data
Jan. 7, 2004 (JP) 2004-001744

(51) Int. Cl. H04N 5/238

(52) U.S. Cl. 348/363

(57) ABSTRACT

A shutter device of an imaging apparatus according to the present invention is interposed between an objective lens and a first lens barrel. An opening and closing unit for moving a shutter blade and an aperture blade to an open or closed position is disposed on a first side of or in the vicinity of an imaginary line extending in a direction orthogonal to an optical axis of the lens. The surface area of the shutter device on a second side of the imaginary line is smaller than the surface area of the first side. Actuators for moving the lens barrel along the optical axis are disposed in the vicinity of the second side of the shutter device. In this way, the length of the shutter device in the optical axis direction becomes short.

### BACKGROUND OF THE INVENTION

1. Field of the Invention

The present invention relates to an imaging apparatus including an imaging element, such as a charge coupled device (CCD) or a complementary metal-oxide semiconductor (CMOS), and having a shutter device for opening and closing a lens barrel.

2. Description of the Related Art

In general, an imaging apparatus (not illustrated in the drawings) included in a digital camera or a cellular phone has a shutter device interposed between a lens barrel having a small first lens and a small second lens (objective lens). Moreover, an imaging element, such as a CCD or a CMOS, is disposed on the same side as in which an image is formed by the light transmitted through the lens.

The lens barrel comprises a first lens barrel having a zoom lens and a second lens barrel having a focus lens. An actuator is connected to each of the lens barrels to move the lens barrel along the optical axis of the lenses.

The shutter device, as disclosed in Japanese Unexamined Patent Application Publication No. 2002-345225, includes two shutter blades having rotational centers on the outside of an opening formed on the optical axis of the lenses. The shutter blades are disposed opposite each other.

The shutter blades are rotated in opposite directions by rotation-driving means, such as stepping motors, disposed on the outside of the opening so as to move the shutter blades to an open or closed position for opening or closing the opening.

The shutter device having the above-mentioned structure rotates the shutter blades, which are disposed in opposite positions, by rotating the rotation-driving means, such as stepping motors, in opposite directions. The shutter device is a cylinder disposed in the chassis of the imaging device. The center of the opening of the shutter device is aligned with the center of the lens axis.

As disclosed in Japanese Unexamined Patent Application Publication No. 5-322502, actuators capable of moving lens barrels along the lens axis comprises a coil and magnets. The coil is movably supported on a horizontally disposed supporting shaft, which is disposed in parallel with the lens axis, so that the coil can be reciprocated along the supporting shaft. The magnets are disposed at both ends of the supporting shaft. The lens barrels are directly connected to the coil.

Such actuators are disposed horizontally and in parallel with the lens axis. The coil is reciprocated along the supporting shaft when the magnetic flux of the coil generated when electricity is applied to the coil affects the magnetic flux of the magnets. In this way, the lens barrels move along the lens axis to enable zooming and focusing operations.

A known imaging apparatus including actuators disclosed in Japanese Unexamined Patent Application Publication No. 5-322502 cannot be reduced in size in the radial direction of the lens even when the distances between the lens barrels and the actuators are reduced. This is because the horizontally disposed actuators and the outer surfaces of the cylindrical lens barrels interfere with each other and cause the shutter device and the actuator to come into contact.

For this reason, the shutter device of a known imaging apparatus is disposed such that it does not interfere with the actuators.

### SUMMARY OF THE INVENTION

A known imaging apparatus having a shutter device disposed such that it does not interfere with actuators is long in the optical axis direction. The size of a known imaging apparatus becomes large because the length of the shutter device is added to the length of the actuators. Because of this large-sized imaging apparatus, it becomes difficult to reduce the size of a digital camera or a cellular phone that incorporates the imaging apparatus.

When the length of the shutter device is reduced in the optical axis direction by disposing the shutter device above the actuators, the distance between the optical axis of the lenses and the actuators has to be increased so that the shutter device does not come into contact with the actuators. As a result, the diameter of the lens becomes large.

To solve the above-mentioned problems, the present invention provides an imaging apparatus with a reduced length in the direction of the optical axis of the lenses without increasing the diameter of the lenses.

To solve the above-mentioned problems, the imaging apparatus according a first aspect of the present invention comprises an imaging element, an objective lens disposed opposite to the imaging element, a second lens having a predetermined diameter interposed between the imaging element and the objective lens, a lens barrel including the objective and second lenses and movable along the optical axis of the lenses, and a shutter device including a shutter blade capable of blocking light that has been transmitted through the objective lens from entering the second lens. The shutter blade and an opening and closing unit for moving this shutter blade to an open or closed position are disposed on a first side of or in the vicinity of an imaginary line extending in a direction orthogonal to the optical axis of the lenses. The surface area of the shutter device on a second side of the imaginary line is smaller than the surface area of the first side, causing the shutter device to have an asymmetrical shape. An actuator for moving the lens barrel along the optical axis of the lenses is disposed in positions opposing the second side of the shutter device.

To solve the above-mentioned problems, the shutter device of the imaging apparatus according to a second aspect of the present invention comprises a shutter blade and an aperture blade capable of adjusting the amount of light entering the lenses included in the lens barrel. The shutter blade and the aperture blade are each engaged to an opening and closing unit. The shutter blade and the aperture blade are driven independently.

To solve the above-mentioned problems, the opening and closing units of the imaging apparatus according a third aspect of the present invention are disposed in opposing positions relative to the optical axis of the lenses.

To solve the above-mentioned problems, the lens barrel of the imaging apparatus according to a fourth aspect of the present invention comprises a first lens barrel having a zoom lens and a second lens barrel having a focus lens, and the actuator of the imaging apparatus comprises first and second actuators for independently moving the first and second lens barrels, respectively. The first and second actuators are disposed on the second side of the shutter device.

To solve the above-mentioned problems, the actuator of the imaging apparatus according to a fifth aspect of the present invention comprises a cylindrical fixed coil, a movable body disposed inside the fixed coil and movable in a direction parallel to the optical axis of the lens, and a cover covering the coil and the outer surface of the movable body. The movable body includes an arm extending to the outside of the cover for supporting the lens barrels. Since part of the arm is supported by a supporting shaft, the movable body can be reciprocated in directions parallel to the optical axis of the lenses.

The movable body comprises a driving magnet. One end of the driving magnet is supported by the arm that is supported by the supporting shaft and has a free end disposed inside the cover.

The shutter blade and an opening and closing unit for moving this shutter blade to an open or closed position are disposed on a first side of or in the vicinity of an imaginary line extending in a direction orthogonal to the optical axis of the lenses. The surface area of the shutter device on a second side of the imaginary line is smaller than the surface area of the first side, causing the shutter device to have an asymmetrical shape. An actuator for moving the lens barrel along the optical axis of the lenses is disposed in positions opposing the second side of the shutter device. In this way, an imaging apparatus having a reduced size can be provided.

The shutter device comprises a shutter blade and an aperture blade capable of adjusting the amount of light entering the lenses disposed in the lens barrel. The shutter blade and the aperture blade are each engaged to an opening and closing unit. The shutter blade and the aperture blade are driven independently. Accordingly, light entering the lenses can be blocked reliably to adjust the amount of light entering the lenses.

The opening and closing units are disposed in opposing positions relative to the optical axis of the lenses. Accordingly, the shutter blade and the ND filter are driven quickly and reliably.

The lens barrel comprises a first lens barrel having a zoom lens and a second lens barrel having a focus lens, and the actuator comprises first and second actuators for independently moving the first and second lens barrels, respectively. The first and second actuators are disposed on the second side of the shutter device. Accordingly, the length of the shutter device in the optical axis direction is reduced.

The movable body includes an arm extending to the outside of the cover for supporting the lens barrels. Since part of the arm is supported by a supporting shaft, the movable body can be reciprocated in directions parallel to the optical axis of the lenses. Accordingly, the lens barrel can be reliably reciprocated along the optical axis.

The movable body comprises a driving magnet, wherein one end of the driving magnet is supported by the arm that is supported the supporting shaft and has a free end disposed inside the cover. Accordingly, a reduced-size actuator can reliably and quickly move the lens barrel so that the lens barrel is reciprocated along the optical axis.

### BRIEF DESCRIPTION OF THE DRAWINGS

FIG. 1 is a partially sectional perspective view of an imaging apparatus according to an embodiment of the present invention;

FIG. 2 is a perspective view of the imaging apparatus illustrated in FIG. 1 without a chassis;

FIG. 3 is a perspective view of the imaging apparatus illustrated in FIG. 2 in a dissembled state;

FIG. 4 an exploded perspective view of a shutter device of the imaging apparatus according to the present invention;

FIG. 5 an exploded perspective view of an actuator of the imaging apparatus according to the present invention; and

FIG. 6 is a perspective view of the actuator illustrated in FIG. 5 in an assembled state.

### DESCRIPTION OF THE PREFERRED EMBODIMENTS

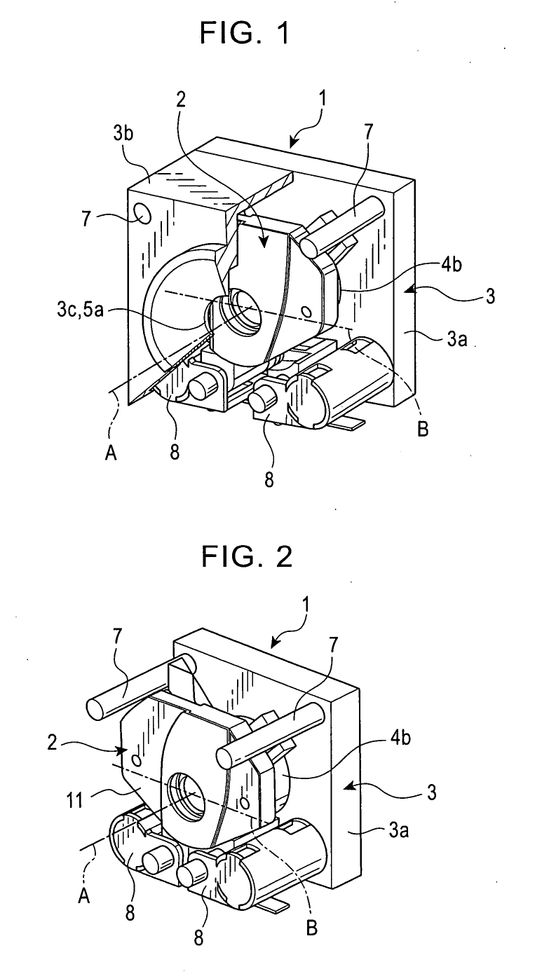

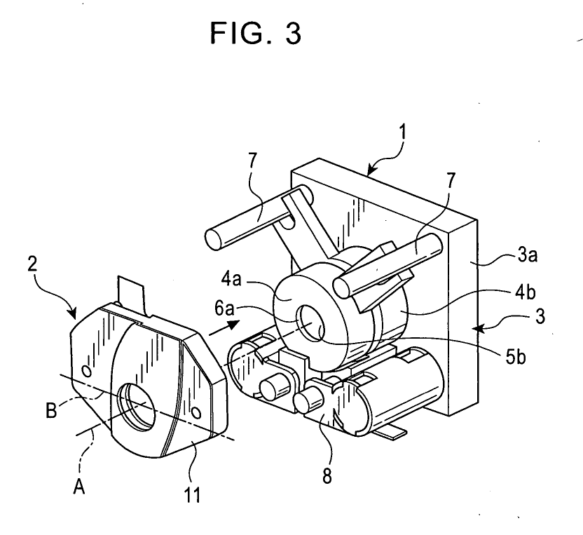

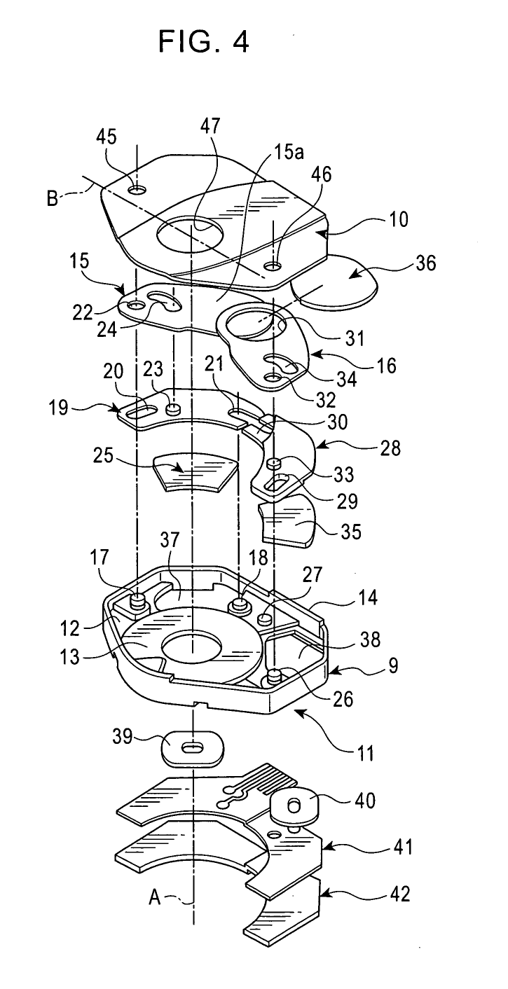

An embodiment of the present invention will now be described with reference to FIGS. 1 to 6. FIGS. 1 to 3 are perspective views of an imaging apparatus 1 according to the present invention. FIG. 4 is an exploded perspective view of a shutter device 2 according to the present invention.

The imaging apparatus 1 according to the present invention comprises the shutter device 2, a main body 3, and first, second, and third lenses 5a, 5b, and 5c (5b and 5c are not shown in the drawings). The first, second, and third lenses 5a, 5b, and 5c are disposed along the optical axis A passing through the center of a base 3a of the main body 3, which has a substantially square cross-section of 10×10 mm.

The first lens 5a is an objective lens supported at an opening 3c formed on a chassis 3b of the main body 3.

The second lens 5b is disposed on a first lens barrel 4a, and the third lens 5c is disposed on a second lens barrel 4b.

The lens 5a, 5b, and 5c are disposed inside the opening 3c, an opening 6a of the lens barrels 4a, and an opening 6b (not shown in the drawings) of the lens barrel 4b, respectively.

The outer wall of the chassis 3b including the first objective lens 5a disposed at the opening 3c is a square that is the same shape as the main body 3. The inside of the chassis 3b is hollow and contains the components of the imaging apparatus 1.

The lens barrels 4a and 4b, as illustrated in FIGS. 1 to 3, are moveably supported along the optical axis A by two upper guide rods 7 and two actuators 8, one for focusing and one for zooming.

An imaging element (not shown in the drawings), such as a CCD or a CMOS, is disposed on the base 3a in an area that intersects with the optical axis A and opposes the second lens barrel 4b.

The surface area of the shutter device 2 is greater for the area above an imaginary line B that is orthogonal to the optical axis A compared to the surface area below the imaginary line B. The shutter device 2 is a pentagon and is asymmetric with respect to the imaginary line B.

The shutter device 2 is interposed between the first and second lenses 5a and 5b by attaching a circular protrusion 13 of a base frame 9, described below, of the shutter device 2 to the first lens barrel 4a. The position of the shutter device 2 may be changed according to the design of the imaging apparatus 1.

As illustrated in the exploded perspective diagram of FIG. 4, various components are disposed inside and below a case 11 constituted from the base frame 9 and a cover 10 placed over the upper portion of the base frame 9.

The circular protrusion 13 is formed on a base plate 12 of the base frame 9. The circular protrusion 13 comes into contact with the object-side of the first lens barrel 4a with its center being aligned with the optical axis A. Links 19 and 28, described below, are interposed between the protrusion 13 and a wall 14.

A shutter blade 15 capable of blocking light that has passed through the first lens 5a and the second lens 5b is disposed on the left half of the case 11, as illustrated in the drawings.

On the right half of the case 11, as illustrated in the drawings, an aperture blade 16 capable of adjusting the amount of light entering the second lens 5b via the first lens 5a is disposed.

Since the blades 15 and 16 are composed of Carbon Feather>, the blades 15 and 16 do not adhere to each other due to static electricity and, thus, rotate smoothly.

To realize the shutter function, the arc-shaped (1/4 of a circle) shutter link 19 having an arc-shaped hole 20 and an arc-shaped notch 21 is attached to the left half of the case 11 by two guide pins 17 and 18 protruding from the base plate 12 of the base frame 9. In this way, the shutter link 19 is reciprocated along the periphery of the case 11.

The shutter blade 15 is disposed on the upper side of the shutter link 19. The shutter blade 15 includes a blocking portion 15a that is large enough to completely cover the opening 6a of the first lens barrel 4a. The guide pin 17 is passed through a hole 22 formed at the edge of the shutter blade 15 to rotatably supported the shutter blade 15.

A driving pin 23 protruding from the shutter link 19 is engaged with a cam groove 24 so as to move the shutter blade 15 to the open or closed position.

A magnet 25 is attached to the lower surface of the shutter link 19 and forms an electromagnetic mechanism for reciprocating the shutter link 19 along the periphery of the case 11 by electromagnetic force.

To realize the aperture function, an arc-shaped (1/4 of a circle) aperture link 28 having an arc-shaped hole 29 and an arc-shaped notch 30 is attached to the left half of the case 11 by two guide pins 26 and 27 protruding from the base plate 12 of the base frame 9 such that the aperture link 28 is reciprocated along the periphery of the case 11 in both directions.

An aperture blade 16 is disposed on the upper side of the aperture link 28. An aperture hole 31 formed on the aperture blade 16 has a diameter larger than the second lens 5b and is capable of adjusting the amount of light entering the second lens 5b. For example, an ND filter 36 is adhesively fixed to the aperture blade 16 to cover the aperture hole 31. The guide pin 26 is passed through a hole 32 formed at the edge of the aperture blade 16 to rotatably support the aperture blade 16.

A driving pin 33 protruding from the aperture link 28 is engaged with a cam groove 34 so as to move the aperture blade 16 to the open or closed position.

The aperture blade 16 may have an aperture hole 31 with a diameter smaller than the diameter of the second lens 5b for adjusting the light entering the second lens 5b.

A magnet 35 is attached to the lower surface of the aperture link 28 and forms an electromagnetic mechanism for reciprocating the aperture link 28 along the periphery of the case 11 by electromagnetic force.

The magnets 25 and 35 are positioned so that their north and south poles are located along the periphery of the case 11. The magnets 25 and 35 are rubber magnets or may be magnets directly printed onto the links 19 and 28.

Transmitting holes 37 and 38 are formed on the base plate 12 of the base frame 9 at locations opposing the magnets 25 and 35.

A flexible printed circuit board (FPC) 41 is disposed on the lower surface of the base frame 9. Coils 39 and 40 wound into a plate are disposed on the FPC 41 and are aligned with the transmitting holes 37 and 38, respectively, at positions opposing the magnets 25 and 35, respectively.

The coils 39 and 40 may be printed onto the FPC 41.

A yoke 42 is disposed on the lower side of the FPC 41.

The cover 10 is fixed by engaging the left and right guide pins 17 and 26 with holes 45 and 46 of the cover 10. A transmitting hole 47 having a center aligned with the optical axis A is formed on the cover 10.

The cover 10 and the yoke 42 are composed of ferromagnetic material, such as tinned steel plate, to form a magnetic circuit.

A shutter unit according to this embodiment comprises the shutter blade 15 and the aperture blade 16, the opening and closing unit according to this embodiment comprises the shutter link 19 and the aperture link 28, and the electromagnetic driving mechanism according to this embodiment comprises the magnets 25 and 35, the coils 39 and 40, the yoke 42, and the cover 10.

The shutter unit and the opening and closing unit are disposed in the vicinity of or above the imaginary line B (extending in a direction orthogonal to the optical axis A of the lens, as illustrated in the drawings) in the upper portion of the shutter device 2. In this way, the shutter device 2 has an asymmetrical shape wherein the surface area below the imaginary line B is smaller than the surface area above the imaginary line B.

As illustrated in FIGS. 1 to 3, the horizontally disposed actuators 8 capable of moving the first and second lens barrels 4a and 4b along the optical axis A are disposed in the area below the imaginary line B in positions opposing the lower half of the shutter device 2.

In other words, the shutter device 2 is disposed in the vicinity of the actuators 8 so that the lower half of the shutter device 2 having a smaller surface area opposes the actuators 8.

According to the above-described arrangement, the length of the imaging apparatus 1 in the optical axis direction can be minimized since the shutter device 2 is thin and does not significantly affect the length of the imaging apparatus 1.

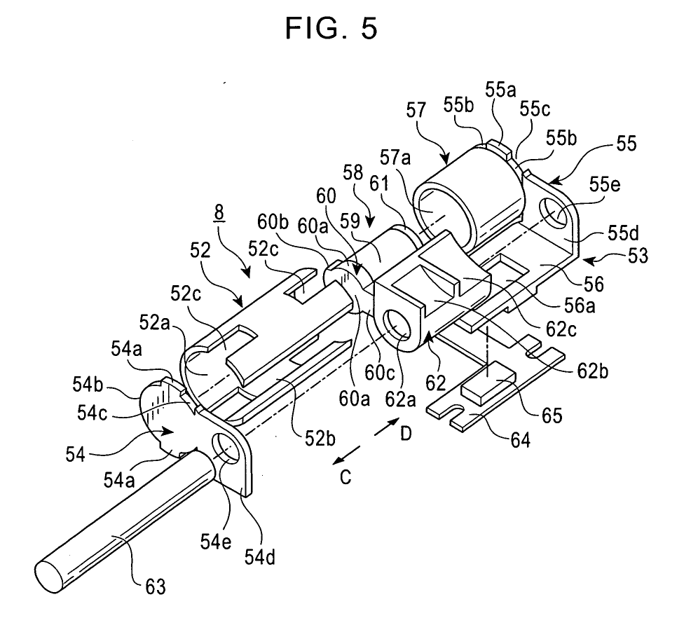

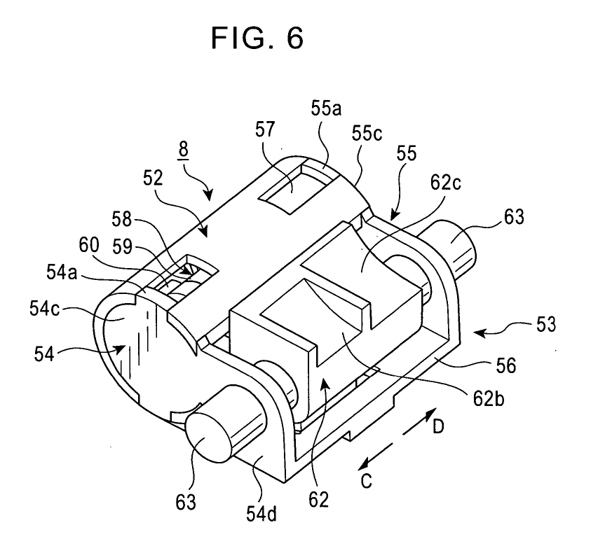

Each of the actuators 8, which are capable of moving the first and second lens barrels 4a and 4b along the optical axis A, includes a cylindrical cover 52, as illustrated in FIGS. 5 and 6.

The cover 52 is composed of a magnetic material, such as a steel plate. The cover 52 has an inner space 52a and an opening 52b. The opening 52b is formed at the front of the outer wall of the cover 52 has a predetermined width, as illustrated in the drawings. The inner space 52a is exposed through the opening 52b.

Notches 52c, each having a predetermined width and length, are formed on the left and right edges of the cover 52 in the longitudinal direction.

The ends of the cover 52 are supported by first and second plates 54 and 55 of a support 53. The first and second plates 54 and 55 include cover supports 54c and 55c, respectively, and shaft stoppers 54d and 55d, respectively. Protrusions 54a and 55a and depressions 54b and 55b are formed on the peripheries of the cover supports 54c and 55c, respectively. The shaft stoppers 54d and 55d extend forward from the cover supports 54c and 55c, respectively, as illustrated in the drawings.

Shaft stopper holes 54e and 55e for journalling a support shaft 63 is formed on the shaft stoppers 54d and 55d, respectively.

The support 53 is an L-shaped single piece including the second plate 55, which is the vertical portion, and a base 56, which is the horizontal portion, as illustrated in the drawings. A rectangular sensor hole 56a is formed on the base 56.

The first plate 54 is attached to the left edge of the based 56, as illustrated in the drawings, by an adhesive or by spot welding to constitute the substantially U-shaped support 53.

A coil 57 having a cavity 57a is fixed to the cover support 55c of the second plate 55 by an adhesive.

The other end of the coil 57 opposite from the end adhered to the cover support 55c is exposed. The cover support 55c of the second plate 55 supports the cover 52. The coil 57 is stored inside the inner space 52a of the cover 52.

The length of the cover 52 is about twice as long as the coil 57. Therefore, when the cover 52 is supported by the cover support 55c of the second plate 55 in which the coil 57 is adhered to, the right half of the opening 52b is shielded by the coil 57, as illustrated in the drawings.

As illustrated in the drawings, the left half of the opening 52b of the cover 52 is exposed such that the inner space 52a is visible from outside.

A movable body 58 is disposed inside the inner space 52a of the cover 52. A part of the movable body 58 is located inside the cavity 57a of the coil 57. As illustrated in the drawings, the movable body 58 is movable towards the left and right (in the directions indicated by arrow C and D) in the inner space 52a and the cavity 57a.

The movable body 58 comprises a columnar driving magnet 59, which is a permanent magnet, and first and second yokes 60 and 61, which are composed of a magnetic material. The first and second yoke 60 and 61 are fixed with an adhesive to the left and right ends of the driving magnet 59.

The first yoke 60 includes a magnet-fixing unit 60a having an outer diameter the same as the driving magnet 59. A protrusion 60b protrudes in a predetermined length from the magnet-fixing unit 60a so that the protrusion 60b is positioned adjacent to the inner periphery of the cover 52.

The first yoke 60 includes an arm 60c, which extends from the magnet-fixing unit 60a in a direction opposite to the protrusion 60b. The arm 60c is positioned inside the opening 52b of the cover 52 and is movable in the directions indicated by the arrows C and D in the drawings.

As illustrated in the drawings, a link 62 formed as a single unit with the first yoke 60 by insert molding is formed on the right tip of the arm 60c.

The link 62 includes a support hole 62a, as described below, for journalling the support shaft 63.

The link 62 is wide in the longitudinal direction of the support shaft 63. The support hole 62a is formed on this wide area of the link 62. The support shaft 63 is journalled by the support hole 62a such that the movable body 58 is movable in the directions indicated by the arrows C and D.

A catching part 62b and an engagement part 62c are formed on the wide portion of the link 62 by cutting out an arc-shaped portion from the upper right corner of the link 62, as illustrated in the drawings.

The first and second lens barrels 4a and 4b are engaged with and supported by the catching part 62b.

The first and second lens barrels 4a and 4b are slidably supported by the engagement part 62c.

The support shaft 63 is passed through the support hole 62a so that the movable body 58 is supported moveably in the directions indicated by the arrows C and D, as illustrated in the drawings.

An attractive force acts on the movable body 58, which is supported by the support shaft 63 at one end, such that the movable body 58 is attracted towards the inner surface of the cover 52 by the magnetic flux of the driving magnet 59 affecting the cover 52 via the protrusion 60b of the first yoke 60.

This attractive force causes the free end of the driving magnet 59 to be positioned substantially in the center of the cavity 57a of the coil 57 without touching the inner surface of the coil 57.

The left and right ends of the support shaft 63 are pushed into or adhered to the shaft stopper holes 54e and 55e of the first and second plates 54 and 55, respectively, of the support 53.

A magnetic sensor 65 constituted of a hall element soldered to an FPC 64 is disposed in the sensor hole 56a formed on the base 56 of the support 53.

The magnetic sensor 65 detects the change in the magnetic flux generated at the arm 60c of the first yoke 60 to detect the direction and amount of the movement of the movable body 58.

The actuators 8 are assembled as illustrated in FIG. 6. When electricity is applied in one direction to the coil 57 while the free end of the driving magnet 59 and the second yoke 61 of the movable body 58 is disposed in the cavity 57a of the coil 57, the magnetic flux generated at the coil 57 based on Fleming's law affects the magnetic flux of the driving magnet 59, causing the movable body 58 to move in the direction indicated by the arrow C. Since the protrusion 60b of the first yoke 60 is attracted to the inner surface of the cover 52 by a predetermined attractive force, the free end of the driving magnet 59 is positioned substantially in the center of the cavity 57a of the coil 57. In this way, the movable body 58 is movable in the directions indicated by the arrows C and D.

Now the operation of the imaging apparatus 1 according to the present invention and having the above-described structure will be described. In the initial position, the shutter blade 15 and the aperture blade 16 are in an open position wherein the opening 6a of the first lens barrel 4a is completely open.

In this initial position, electricity is applied individually to the coils 39 and 40 in the normal and reverse directions so as to independently control the shutter blade 15 and the aperture blade 16 to open and close the opening 6a. When electricity is applied to the coil 39 while the shutter blade 15 is at an initial position wherein the opening 6a is open, the generated magnetic field affects the magnetic field of the magnet 25, rotating the shutter link 19 in a counterclockwise direction.

In this way, the driving pin 23 of the shutter link 19 presses the cam groove 24 of the shutter blade 15, rotating the shutter blade 15 in the clockwise direction around the guide pin 17.

As the shutter link 19 rotates in the counterclockwise direction, the shutter blade 15 moves to completely close the opening 6a of the first lens barrel 4a.

When electricity is applied to the coil 39 in the reverse direction, the shutter blade 15 rotates in the counterclockwise direction to completely open the opening 6a.

Now the opening and closing movements of the aperture blade 16 will be described. When electricity is applied to the coil 40 while the ND filter 36 covering the aperture hole 31 is at an initial position wherein the opening 6a is open, the generated magnetic field affects the magnetic field of the magnet 35, rotating the aperture link 28 in a clockwise direction. In this way, the driving pin 33 of the aperture link 28 presses the cam groove 34 of the aperture blade 16, rotating the aperture blade 16 in the counterclockwise direction around the guide pin 26.

As the aperture link 28 rotates in the clockwise direction, the ND filter 36 moves to close the opening 6a of the first lens barrel 4a so as to control the amount of light passing through the opening 6a. When electricity is applied to the coil 40 in the reverse direction, the aperture blade 16 rotates in the clockwise direction to completely remove the ND filter 36 from the opening 6a.

When the magnets 25 and 35 are reciprocated along the periphery of the case 11 together with the links 19 and 28, the peripheral edges of the magnets 25 and 35 move close to the edge of the yoke 42 or the peripheral edge of the transmitting hole 47. As a result, the magnetic attractive force biases the magnets 25 and 35 so that the magnets 25 and 35 are maintained in positions along the periphery of the case 11.

In this way, the position of the ND filter 36 attached to the shutter blade 15 and the aperture blade 16 can easily be moved to an open, closed, or predetermined aperture position.

If shock is accidentally applied from the outside, the opening 6a will not be closed by the shutter blade 15 and the ND filter 36.

The actuators 8 each operate independently and reciprocate the first and second lens barrels 4a and 4b in both directions along the optical axis A to enable focusing and zooming operations.

As described above, the shutter device 2 according to the present invention comprises the shutter blade 15, the ND filter 36, and the opening and closing units for the shutter blade 15 and the ND filter 36. However, the shutter device 2 according to the present invention may comprise the shutter blade 15 and only one opening and closing unit.

Since the imaging apparatus 1 according to the present invention has a short length in the optical axis direction, a digital camera or a cellular phone incorporating the imaging apparatus 1 can have a reduced-size.

Even when shock is applied from the outside to the blocking portion 15a of the shutter blade 15 in a direction that causes the opening 6a of the lens barrels 4a and 4b to close, rotation of the shutter blade 15 is prevented since both ends of the shutter link 19 are attached to the case 11 to prohibit rotation.

The imaging apparatus 1 according to the present invention has space for devices, such as actuators, to be disposed in the area excluding the shutter unit disposed in the projection area along the optical axis A of the lenses. The size of the shutter device 2 according to the present invention can be reduced significantly. Moreover, the shutter device 2 according to the present invention has both shutter and aperture functions and operates accurately. The imaging apparatus 1 according to the present invention is not limited to the embodiment described above and necessary modifications may be made within the scope of the invention.

1. An imaging apparatus comprising:
an imaging element;
an objective lens disposed opposite the imaging element;
a second lens interposed between the imaging element and the objective lens and having a predetermined diameter;
a lens barrel including the objective lens and the second lens and capable of moving along an optical axis of the lenses; and
a shutter device;
the shutter device comprising:
a shutter blade capable of blocking light that has passed through the objective lens from entering the second lens; and
an opening and closing unit for moving the shutter blade to an open or closed position;
wherein the shutter blade and the opening and closing unit are disposed on a first side of or in the vicinity of an imaginary line extending in a direction orthogonal to the optical axis of the lenses,
wherein the shutter device has an asymmetrical shape and a surface area of the shutter device on a second side of the imaginary line is smaller than a surface area of the first side, and
wherein an actuator for moving the lens barrel along the optical axis of the lenses is disposed on the imaging apparatus in positions opposing the second side of the shutter device.

2. The imaging apparatus according to claim 1,
wherein the shutter device further comprises an aperture blade capable of adjusting an amount of light entering the lenses included in the lens barrel,
wherein the aperture blade and the shutter blade are each engaged to a different opening and closing unit, and
wherein the shutter blade and the aperture blade are driven independently.

3. The imaging apparatus according to claim 2, wherein the opening and closing units are disposed in opposing positions relative to the optical axis of the lenses.

4. The imaging apparatus according to claim 2,
wherein the lens barrel comprises:
a first lens barrel including a zoom lens; and
a second lens barrel including a focus lens;
wherein the actuator comprises:
a first actuator capable of independently moving the first lens barrel; and
a second actuator capable of independently moving the second lens barrel; and
wherein the first and second actuators are disposed in a position opposite the second side of the shutter device.

5. The imaging apparatus according to claim 1,
wherein the actuator comprises:
a cylindrical fixed coil;
a movable body including an arm extending to an outside of the cover for supporting the lens barrels, the movable body being disposed inside the fixed coil and being movable in both directions parallel to the optical axis of the lenses; and
a cover covering the coil and the outer surface of the movable body; and
wherein the movable body can be reciprocated in both directions parallel to the optical axis of the lenses while part of the arm is supported by a supporting shaft, and
wherein the lens barrel is reciprocated cooperatively with the movable body.

6. The imaging apparatus according to claim 5, wherein the movable body further comprises a driving magnet, the driving magnet having one end supported by the arm that is supported by the supporting shaft and having an opposing free end disposed inside the cover.
